(19) United States
(12) Patent Application Publication
(10) Pub. No.: US 2009/0002309 A1
(43) Pub. Date: Jan. 1, 2009

(54) Semiconductor Integrated Circuit, Power Source System Interface, and Electronic Apparatus

(75) Inventors: Kota ONISHI, Nagoya (JP); Izumi Umeda, Nagoya (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/137,099

(22) Filed: Jun. 11, 2008

(30) Foreign Application Priority Data
Jun. 12, 2007 (JP) 2007-154794

(51) Int. Cl. G09G 3/36

(52) U.S. Cl. 345/102

(57) ABSTRACT

A semiconductor integrated circuit, includes: a light emitting diode driver for driving a light emitting diode which is a backlight source of a liquid crystal display panel; a regulator that stabilizes an externally supplied power supply voltage, so as to supply a power supply voltage which is stabilized to a liquid crystal driver that drives the liquid crystal panel; a level shifter which shifts a level of image data supplied to a data input terminal, so as to supply, to the liquid crystal driver, image data that has a level corresponding to the power supply voltage stabilized by the regulator; and a control circuit which switches on/off an operation of at least one of the light emitting diode driver and the regulator, in accordance with a command supplied to the data input terminal; wherein the semiconductor integrated circuit is used, being coupled to the liquid crystal display panel and to the liquid crystal driver.

The entire disclosure of Japanese Patent Application No. 2007-154794, filed, Jun. 12, 2007 is expressly incorporated by reference herein.

### BACKGROUND

1. Technical Field

The present invention relates to a semiconductor integrated circuit which is used together with a liquid crystal display panel (LCD panel), as well as to a power source system interface including the semiconductor integrated circuit.

2. Related Art

Small-sized LCD panels are used for electronic apparatuses such as printers and mobile phones. Light emitting diodes (LEDs) are widely used as a light source of a backlight in small-sized LCD panels, and those LEDs are driven in a constant current in order for those LEDs to emit light in a predetermined brightness.

Values of power supply voltages vary for LCD drivers that drive the LCD panels depending on their models. Therefore, a power supply voltage suitable to each LCD driver needs to be generated, and the level of image data to be supplied to the LCD driver needs to be shifted accordingly.

Here, mounting a power source system interface into a single chip achieves lower cost, and lower current consumption in a small-footprint. Such a power source system interface supplies the desired power supply voltage and the image data to the LCD driver for driving the LCD panel, as well as to the LED used as the light source of the backlight for the LCD panel.

JP-A-2005-195746 (page 4-5, FIG. 1) discloses, as related art, an electronic apparatus that includes: a display driver which flexibly complies with display characteristics of a display panel without much effect caused on the display status by the display panel; and a processor unit (MPU) which controls such a display driver.

In this electronic apparatus, display characteristics parameters corresponding to the display characteristics of the display panel are written into a one-time PROM (OTP) circuit at an initial setting; a control register stores the display characteristics parameters supplied from the OTP circuit; a read-out signal is output to the OTP circuit when the control circuit reads out the display characteristics from the OTP circuit; a write-in signal is output to the OTP circuit when writing in the display characteristics parameter to the OTP; and a refresh operation is carried out in a predetermined timing, so as to read out the display characteristics parameters from the OTP circuit and re-write it into the control register. However, there is no description in JP-A-2005-195746 about lighting the backlight in the display panel, nor of generating a power supply voltage for a driver in accordance with the model of the display panel.

### SUMMARY

Advantages of the invention are to achieve a low cost, low current consumption, and a small-footprint semiconductor integrated circuit used together with an LCD panel, as well as to easily couple the semiconductor integrated circuit with controllers such as MPU and CPU. Moreover, another advantage of the invention is to realize a power source system interface for an LCD panel by using such a semiconductor integrated circuit.

According to a first aspect of the invention, a semiconductor integrated circuit includes: a light emitting diode driver for driving a light emitting diode which is a backlight source of a liquid crystal display panel; a regulator that stabilizes an externally supplied power supply voltage, so as to supply a power supply voltage which is stabilized to a liquid crystal driver that drives the liquid crystal panel; a level shifter which shifts a level of image data supplied to a data input terminal, so as to supply, to the liquid crystal driver, image data that has a level corresponding to the power supply voltage stabilized by the regulator; and a control circuit which switches on/off an operation of at least one of the light emitting diode driver and the regulator, in accordance with a command supplied to the data input terminal. Here, the semiconductor integrated circuit is used, being coupled to the liquid crystal display panel and to the liquid crystal driver.

In this case, the control circuit may start, in accordance with a first command supplied to the data input terminal, an operation of the regulator, and thereafter may start an operation of the light emitting diode driver as well as a supplying of image data to the liquid crystal driver. Moreover, the control circuit may stop an operation of the light emitting diode driver in accordance with a second command supplied to the data input terminal, and may also stop the supplying of the image data to the light emitting diode driver, in accordance with a third command supplied to the data input terminal.

This semiconductor integrated circuit may further include a communication interface that converts serial data supplied to the data input terminal to parallel data. This communication interface may output image data contained in the parallel data to frame memory, and may also output a command contained in the parallel data to the control circuit. In this case, the level shifter shifts a level of parallel image data read out from the frame memory.

This semiconductor integrated circuit may further include a second regulator for stabilizing an externally supplied power supply voltage, so as to generate a first voltage; and a boost circuit for boosting the first voltage and generating a second voltage, so as to supply the second voltage obtained to the light emitting diode which is the backlight sources of the liquid crystal display panel. In this case, a voltage supply circuit may boost the first voltage by a factor of N so as to generate the second voltage, where N is an integer greater than or equal to 2.

According to a second aspect of the invention, a power source system interface, includes the semiconductor integrated circuit according to claim 1, and a resistor and a capacitor both of which being externally supplied to the semiconductor integrated circuit.

According to a third aspect of the invention, a semiconductor integrated circuit which is for operating an electro-optical element includes a driver for driving a light emitting element, a regulator for supplying a power source voltage, a level shifter which shifts a level of image data, and a control circuit that controls an operation of one of the driver and the regulator.

According to the aspects of the invention, a single semiconductor integrated circuit is provided with functionalities of supplying image data and a desired power supply voltage to the LED of the LCD panel as well as to the LCD driver, thereby achieving lower cost, and lower current consumption in a small-footprint. At the same time, a single data input terminal is used for inputting both image data and a command in the semiconductor integrated circuit, thereby allowing the circuit to be easily coupled with controllers such as MPU and CPU. Moreover, a power system interface for the LCD panel is realized by using such a semiconductor integrated circuit.

### BRIEF DESCRIPTION OF THE DRAWINGS

The invention will be described with reference to the accompanying drawings, wherein like numbers reference like elements.

FIG. 1 is a block diagram illustrating an electronic apparatus including a power source system interface according to aspects of the invention.

FIG. 2 is a drawing illustrating the power source system interface according to an embodiment of the invention.

FIG. 3 is a circuit diagram illustrating a configuration of an LED driver shown in FIG. 2.

FIG. 4 is a drawing illustrating part of the power source system interface according to another embodiment of the invention.

### DESCRIPTION OF EXEMPLARY EMBODIMENTS

An exemplary embodiment of the invention will now be described in detail with references to the drawings. The same reference numbers are used for the same constituting members, and the description thereof is omitted.

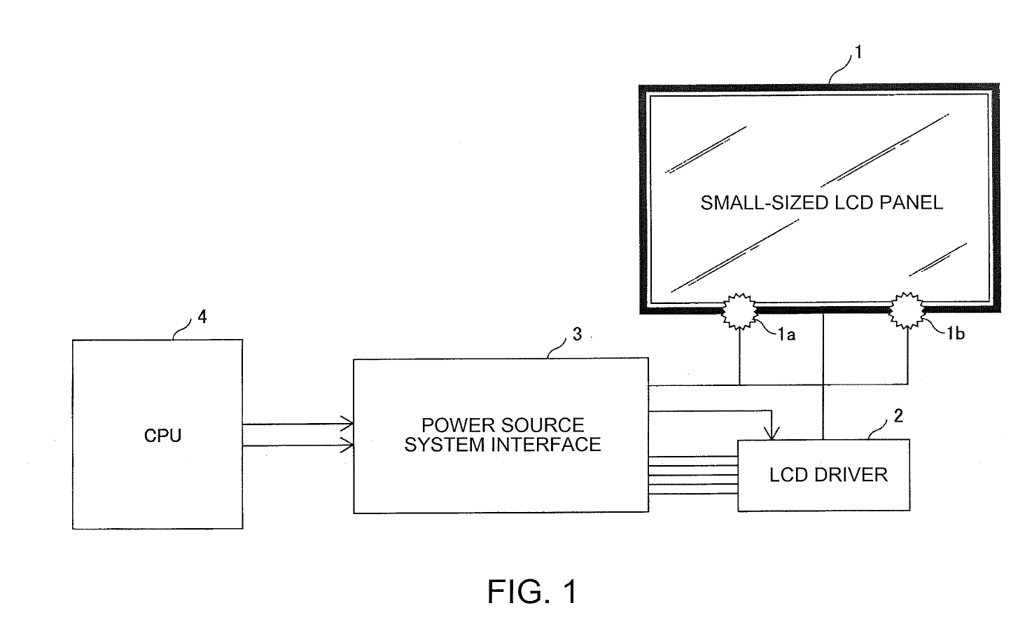

FIG. 1 is a block diagram illustrating part of the configuration of an electronic apparatus that includes the power system interface according to the embodiments of the invention. Hereafter, an example of this electronic apparatus describes a printer.

As shown in FIG. 1, the printer includes a small-sized liquid crystal display panel (LCD panel) 1 that includes two LEDs 1a and 1b as backlight sources, an LCD driver 2 for driving the LCD panel 1, a power source system interface 3 that drives the LEDs 1a and 1b and supplies image data and a power supply voltage to the LCD driver 2, and a central operation unit (CPU) 4 for supplying information such as image data and commands to the power source system interface 3. The small-sized liquid crystal display panel means a liquid crystal display panel with a size of up to approximately 2 inches.

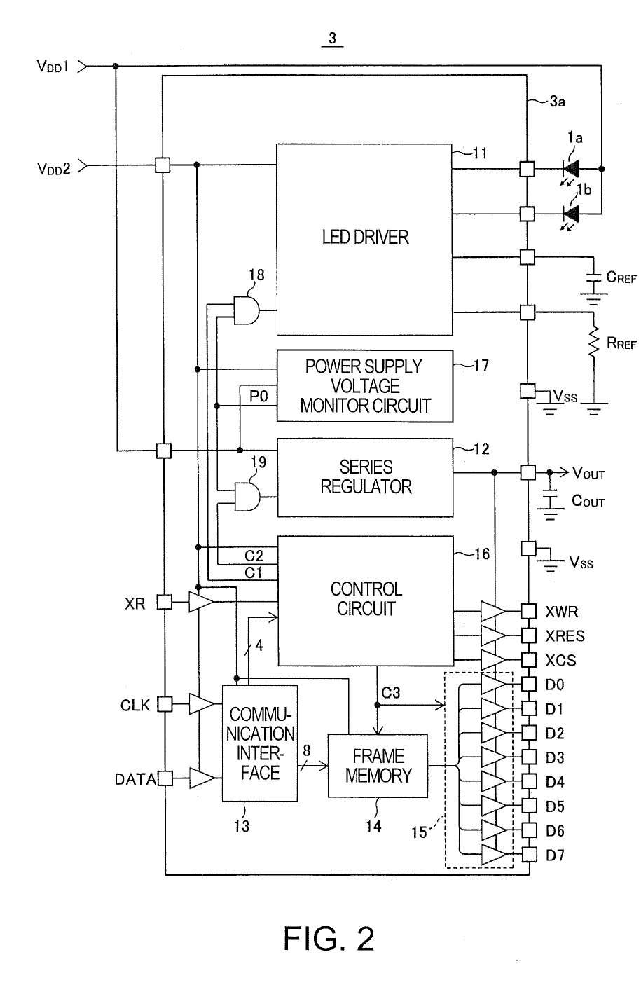

FIG. 2 is a block diagram illustrating a configuration of the power source system interface according to a first embodiment of the invention. As shown in FIG. 2, the power source system interface 3 is formed with a semiconductor integrated circuit 3a, including an LED driver 11, a series regulator 12, a communication interface 13, a frame memory 14, a level shifter 15 for image data, a control circuit 16, a power supply voltage monitor circuit 17, and AND gates 18 and 19.

In this embodiment, the power potential V_{SS} is a ground potential, and the power source system interface 3 operates when a power supply voltage V_{DD}1 (for instance, 5V) and a power supply voltage V_{DD}2 (for instance, 3.3V) are supplied externally. The power supply voltage V_{DD}1 is also supplied to anodes of the LEDs 1a and 1b which are the backlight sources of the LCD panel.

An inverted resetting signal XR, a clock signal CLK, and serial data DATA output from a CPU4 (FIG. 1) are respectively input into a reset signal input terminal, a clock signal input terminal, and a data input terminal of the semiconductor integrated circuit 3a. The inverted resetting signal XR is supplied to the control circuit 16, and the clock signal CLK and the serial data DATA are supplied to the communication interface 13. The serial data DATA includes, in addition to the image data, various commands and parameters.

The LED driver 11 generates a reference voltage based on the power supply voltage V_{DD}2, and a constant current configured based on the reference voltage generated as well as on the external resistor R_{REF} flows in the LEDs 1a and 1b which are the backlight sources of the LCD panel. An external capacitor C_{REF} is used for smoothing the reference voltage.

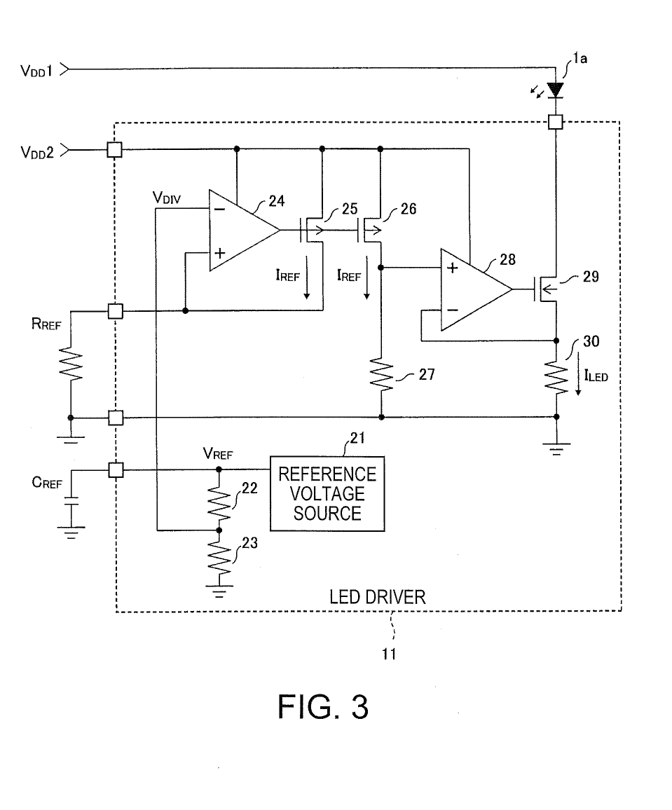

FIG. 3 is a circuit diagram illustrating a configuration of the LED driver shown in FIG. 2. A circuit configuration to light a single LED1a is displayed in FIG. 3. As shown in FIG. 3, the LED driver 11 includes: a reference voltage source 21 for generating a reference voltage V_{REF} which serves as a reference; resistors 22 and 23 that generate divided voltage V_{DIV} by dividing the reference voltage V_{REF}, an op-amp 24 in which the divided voltage V_{DIV} is input into an inverted input terminal; p-channel metal oxide semiconductor field effect transistors (MOSFET) 25 and 26 in which the gates thereof are coupled with an output terminal of the op-amp 24; a resistor 27 coupled between the ground potential and a drain of the transistor 26; an op-amp 28 in which a voltage generated at the resistor 27 is input into an non-inverted input terminal; an n-channel MOSFET 29 in which an output terminal of the op-amp 28 is coupled with the gate thereof; and a resistor 30 coupled between the ground potential and a source of the transistor 29.

The external resistor R_{REF} is coupled to the drain of the transistor 25, and a voltage generated in the resistor R_{REF} is input to a non-inverted input terminal of the op-amp 24. In this structure, feedback is applied to the op-amp 24, making the voltage of the inverted input terminal equal to that of the non-inverted input terminal. Therefore, the magnitude of a drain current I_{REF} of the transistor 25 is expressed in the following formula (1):

I_{REF}=V_{DIV}/R_{REF}

wherein, if the size of the transistor 25 equals to that of the transistor 26, the drain current I_{REF} with the same magnitude as that of the transistor 25 flows in the transistor 26.

A voltage generated in the resistor 30 is input into the non-inverted input terminal of the op-amp 28. In this structure, feedback is applied to the op-amp 28, making the voltage generated in the resistor 27 equal to that of the resistor 30. If the resistance of the resistor 27 and the resistor 30 are represented as R27 and R30 respectively, a current flowing in the resistor 30, in other words, a current ILED flowing in the LED1a is expressed in the following formula (2):

I_{LED}=I_{REF}*R₂₇/R₃₀

The following formula (3) is obtained from the formulae (1) and (2).

R_{REF}=V_{DIV}*(R₂₇/R₃₀)/I_{LED}

The resistance of the external resistor R_{REF} is determined based on this formula (3). For instance, if the divided voltage V_{DIV}, a resistor R27, a resistor R30, and the current I_{LED} to flow in the LED are respectively 1V, 1.2 kΩ, 6 Ω, and 20 mA, then the resistor R_{REF} is set to 10 k.

Referring back to FIG. 2, the series regulator 12 generates a second reference voltage based on the power supply voltage V_{DD}1, and stabilizes the power supply voltage V_{DD}1 based on the second reference voltage generated, so as to supply a stabilized power supply voltage V_{OUT} to the LCD driver. An external capacitor C_{OUT} is coupled to an output terminal of the power supply voltage V_{OUT}.

The communication interface 13 receives, in synchronization with the clock signal CLK, the serial data DATA supplied through a data input terminal, and converts the serial data DATA to a parallel data. Moreover, the communication interface 13 outputs the image data contained in the parallel data to the frame memory 14, and outputs a command contained in the parallel data to the control circuit 16.

The frame memory 14 stores the parallel image data supplied from the communication interface 13. The level shifter 15 shifts the level of the parallel image data read out from the frame memory 14, thereby supplying, to the LCD driver 2 (FIG. 1), the parallel image data that has a level corresponding to the power supply voltage V_{OUT} which is stabilized by the series regulator 12.

The control circuit 16 generates control signals C1 through C3, in accordance with the inverted resetting signal XR input into the reset signal input terminal, as well as with a plurality of commands supplied to the data input terminal. The control signals C1 through C3 respectively switch on/off the operations of: the LED driver 11 illuminating the backlight, the series regulator 12 supplying the power supply voltage, and at least one of the frame memory 14 and the level shifter 15 supplying the image data. The control circuit 16 supplies an inverted write-in signal XWR, an inverted resetting signal XRES, and a chip select signal XCS to the LCD driver 2.

The power supply voltage monitor circuit 17 monitors the rise of the power supply voltage V_{DD}1 and the power supply voltage V_{DD}2, and it activates a power-on signal PO to a high level at the rise of both the power supply voltage V_{DD}1 and the power supply voltage V_{DD}2. The AND gate 18 obtains a logical AND of the control signal C1 output from the control circuit 16 as well as of the power-on signal PO output from the power supply voltage monitor circuit 17, and outputs the result to the LED driver 11. As a result, the LED driver 11 is operated if both the control signal C1 and the power-on signal PO are activated. Moreover, the AND gate 19 obtains a logical AND of the control signal C2 output from the control circuit 16 and of the power-on signal PO output from the power supply voltage monitor circuit 17, and outputs the result to the series regulator 12. As a result, the series regulator 12 is operated if both the control signal C2 and the power-on signal PO are activated.

Examples of commands supplied from the communication interface 13 to the control circuit 16 include: a first command for switching on the display of the LCD panel; a second command for stopping the operation of the LED driver for power saving; a third command for stopping the supply of the image data toward the LCD driver for power saving; a fourth command for quitting the power saving; and a fifth command for switching off the display of the LCD panel.

The CPU4 illustrated in FIG. 1 sends the first command to the power source system interface 3 at the time of the power switch of the printer being turned on. If the first command is supplied to the control circuit 16 through the data input terminal in the power source system interface 3, the control circuit 16 first starts the power supply voltage supply operation of the series regulator 12 in accordance with the first command, and thereafter starts the operations of the LED driver 11 illuminating the backlight as well as of the frame memory 14 or the level shifter 15 supplying the image data.

The CPU4 transmits the second command to the power source system interface 3, if there is no input of print data or a command to the printer from a device such as a host computer during a first predetermined period. If the second command is supplied to the control circuit 16 through the data input terminal in the power source system interface 3, the control circuit 16 stops, in accordance with the second command, the operations of the LED driver 11 illuminating the backlight.

Moreover, the CPU4 transmits the third command to the power source system interface 3, if there is no input of print data or a command to the printer from the devices such as a host computer during a second predetermined period. If the third command is supplied to the control circuit 16 through the data input terminal in the power source system interface 3, the control circuit 16 stops, in accordance with the third command, the operations of the frame memory 14 or the level shifter 15 supplying the image data.

A second embodiment according to the aspects of the invention will now be described. The power source system interface according to the second embodiment operates only with a single type of power supply voltage V_{DD} (for instance, 3.3V), while the power source system interface according to the first embodiment as shown in FIG. 2 requires two types of power supply voltages V_{DD}1 and V_{DD}2. The rest is the same as that of the first embodiment.

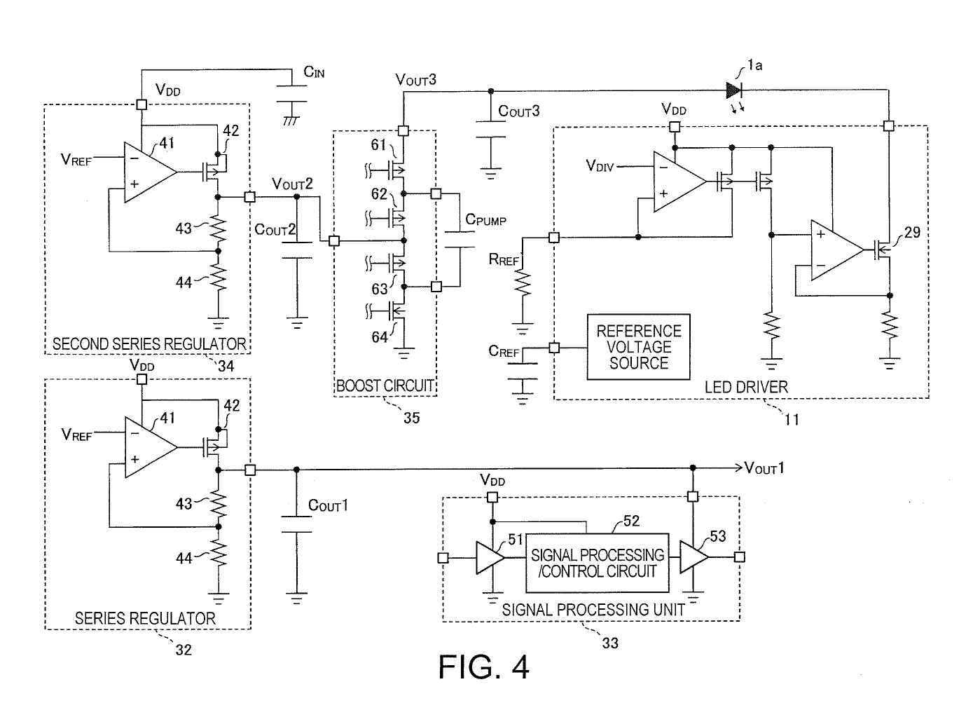

FIG. 4 is a circuit diagram illustrating a part of a configuration of the power source system interface according to the second embodiment of the invention. A circuit configuration for lighting a single LED1a is displayed in FIG. 4. As shown in FIG. 4, this power source system interface includes: the LED driver 11 that operates with a supply of the power supply voltage V_{DD}, a series regulator 32 that stabilizes the power supply voltage V_{DD} and generates a power supply voltage V_{OUT}1 for supplying a power supply voltage to circuitries such as the LED driver 11; a signal processing unit 33 that operates with a supply of power supply voltage V_{DD} and the power supply voltage V_{OUT}1; a second series regulator 34 that stabilizes the power supply voltage V_{DD} and generates a power supply voltage V_{OUT}2 so as to provide a power supply voltage to the LED; and a boost circuit 35 that boosts the power supply voltage V_{OUT}2 and generates a power supply voltage V_{OUT}3, so as to supply the power supply voltage V_{OUT}3 to an anode of the LED1a. Here, sections within dotted lines in FIG. 4 are formed with semiconductor integrated circuits.

The series regulator 32 and the second series regulator 34 each include an op-amp 41 in which the non-inverted input terminal receives the reference voltage V_{REF}, a p-channel MOSFET 42 (hereafter “transistor 42”) to which a gate output terminal of the op-amp 41 is coupled, and resistors 43 and 44 that are coupled in series between a drain of the transistor 42 and the ground potential. In this case, a voltage divided at the coupling point of the resistors 43 and 44 is input into the non-inverted input terminal of the op-amp 41.

Here, an external capacitor C_{IN} is coupled to the input terminal that inputs the power supply voltage V_{DD}; an external capacitor C_{OUT}1 is coupled to the output terminal of the series regulator 32, and an external capacitor C_{OUT}2 is coupled to the output terminal of the second series regulator 34.

Moreover, the signal processing unit 33 includes a plurality of input buffers 51, a signal processing/control circuit 52, and a plurality of level shifters 53. The signal processing/control circuit 52 is equivalent to the communication interface 13, the frame memory 14, and the control circuit 16 shown in FIG. 2.

A charge pump boost circuit, for instance, is used as the boost circuit 35, and such a boost circuit includes components such as p-channel MOSFETs 61 to 63, an n-channel MOSFET 64, and an external capacitor C_{PUMP}. The boost circuit 35 boosts the power supply voltage V_{OUT}2 by a factor of N (where N is an integer not less than 2), and generates the power supply voltage V_{OUT}3. For instance, if the power supply voltage V_{OUT}2 is 2.5V, then the boost circuit 35 boosts the power supply voltage V_{OUT}2 by a factor of 2, and generates 5V of the power supply voltage V_{OUT}3. An external capacitor C_{OUT}3 is coupled to an output terminal of the boost circuit 35. The power supply voltage V_{OUT}3, smoothed by the external capacitor C_{OUT}3, is supplied to the anode of the LED1a.

According to the second embodiment, using only a single type of power supply voltage V_{DD}, operations of lighting the LED and supplying image data as well as a power supply voltage to the LCD driver are carried out. The drain potential of the transistor 42 is applied to one end of the resistor 43, thereby forming a feedback loop in the series regulator 32 as well as in the second series regulator 34 shown in FIG. 4. Alternatively, the feedback loop may also be formed by applying, either the power supply voltage V_{OUT}3 or the source potential of the transistor 29, to one end of the resistor 43.

What is claimed is:

1. A semiconductor integrated circuit, comprising:
a light emitting diode driver that drives a light emitting diode which is a backlight source of a liquid crystal display panel;
a regulator that stabilizes an externally supplied power supply voltage, the regulator supplying a power supply voltage which is stabilized to a liquid crystal driver that drives the liquid crystal panel;
a level shifter that shifts a level of image data supplied to a data input terminal, the level shifter supplying, to the liquid crystal driver, image data that has a level corresponding to the power supply voltage stabilized by the regulator; and
a control circuit that switches on/off an operation of at least one of the light emitting diode driver and the regulator, in accordance with a command supplied to the data input terminal

2. The semiconductor integrated circuit according to claim 1, wherein the control circuit starts, in accordance with a first command supplied to the data input terminal, an operation of the regulator, and thereafter starts an operation of the light emitting diode driver as well as a supplying of image data to the liquid crystal driver.

3. The semiconductor integrated circuit according to claim 2, wherein the control circuit stops an operation of the light emitting diode driver in accordance with a second command supplied to the data input terminal.

4. The semiconductor integrated circuit according to claim 3, wherein the control circuit stops the supplying of the image data to the light emitting diode driver, in accordance with a third command supplied to the data input terminal.

5. The semiconductor integrated circuit according to claim 1, further comprising a communication interface that converts serial data supplied to the data input terminal to parallel data.

6. The semiconductor integrated circuit according to claim 5, wherein the communication interface outputs image data contained in the parallel data to frame memory, and outputs a command contained in the parallel data to the control circuit.

7. The semiconductor integrated circuit according to claim 6, wherein the level shifter shifts a level of parallel image data read out from the frame memory.

8. The semiconductor integrated circuit according to claim 1, further comprising
a second regulator for stabilizing an externally supplied power supply voltage, so as to generate a first voltage; and
a boost circuit for boosting the first voltage and generating a second voltage, so as to supply the second voltage obtained to the light emitting diode which is the backlight sources of the liquid crystal display panel.

9. The semiconductor integrated circuit according to claim 8, wherein a voltage supply circuit boosts the first voltage by a factor of N so as to generate the second voltage, where N is an integer greater than or equal to 2.

10. A power source system interface, comprising:
the semiconductor integrated circuit according to claim 1;
a resistor; and
a capacitor,
both of which being externally supplied to the semiconductor integrated circuit.

11. An electronic apparatus comprising the semiconductor integrated circuit according to claim 1.

12. A semiconductor integrated circuit, comprising:
a driver that drives a light emitting element;
a regulator that supplyes a power source voltage;
a level shifter that shifts a level of image data; and
a control circuit that controls an operation of at least one of the driver and the regulator,
the semiconductor integrated circuit operating an electro-optical element.

13. A power source system interface comprising the semiconductor integrated circuit according to claim 12.

14. An electronic apparatus comprising the semiconductor integrated circuit according to claim 12.
